(19) United States
(12) Patent Application Publication
(10) Pub. No.: US 2008/0196581 A1
(43) Pub. Date: Aug. 21, 2008

(54) Solar Atmospheric CO2 Cleaner

(76) Inventor: Warren Lynn Cooley, Salem, OR (US)

Correspondence Address: Warren L. Cooley, 3260 Bonham St. S, Salem, OR, 97302, US

(21) Appl. No.: 11/934,078

(22) Filed: Nov. 1, 2007

Related U.S. Application Data
(60) Provisional application No. 60/890,190, filed on Feb. 16, 2007.
(60) Provisional application No. 60/944,884, filed on Jun. 19, 2007.

(51) Int. Cl. B03C 1/005

(52) U.S. Cl. 95/28; 96/2

(57) ABSTRACT

An increasing level of carbon dioxide gas in the earth's atmosphere has been determined and is generally accepted by the scientific community. The human contribution to increases in the percentage of carbon dioxide in the atmosphere has been identified as a driving force of global climate change.

The impact of global climate change might be mitigated by means to reduce or stabilize the percentage of carbon dioxide in the atmosphere.

The invention provides a means for cleaning the atmosphere of carbon dioxide molecules by dissociation and refining the by-products into valuable fuels and other substances. It is taught that solar energy can be used to energize a photonic crystal producing the power and specific frequency required for localized excitation of CO2 molecules in a specific vibration mode and to the majority exclusion molecular structures comprising atmospheric gases sufficient to break covalent bonds of CO2, thereby producing reactant by-product that can be collected and refined into valuable substances and fuel.

### REFERENCES

U.S. Pat. No. 5,214,921 June 1993 Cooley 60/641.5

U.S. Pat. No. 7,078,697 July 2006 Barker et al. 250/343

Provisional application US60/890,190 Feb. 16, 2007 Cooley

Provisional application US60/944,884 Jun. 19, 2007 Cooley

### BACKGROUND OF THE INVENTION

Compelling scientific data and consensus have emerged that increasing percentages of carbon dioxide in the atmosphere are contributing to a warming of the earth. Human combustion of hydrocarbons by all manner of devices exhausts carbon dioxide to the atmosphere and contributes to increasing concentrations. Carbon dioxide is known to absorb infrared radiation produced by sunlight striking the earth's surface in its infrared vibration modes. Increasing concentrations of carbon dioxide in the atmosphere are known to absorb increasing units of heat previously reradiated into space. The increased amount of heat trapped by higher concentrations of carbon dioxide is popularly referred to as the “greenhouse effect”. The “greenhouse effect” has been shown to be at least in part related to global climate change. Further, there is emerging evidence that the warming and global climate change are accelerating. This acceleration is probably related to both a “lag-time” factor and the accelerating trends in human hydrocarbon combustion since the beginning of the industrial age. Evidence is beginning to suggest that heretofore naturally occurring sequestration of carbon dioxide in forests and oceans maybe reaching saturation levels creating a “feedback” that further accelerates increasing concentrations of carbon dioxide in the atmosphere, thereby global climate change. Hence, an invention that removes CO2 from the atmosphere by utilizing a benign power source and produces valuable by-product that might be utilized as an alternative fuel source provides a useful, high value technology for mitigating climate change.

### BACKGROUND DISCUSSION OF THE PRIOR ART

Increasing levels of “greenhouse gases” of which carbon dioxide is of principle concern have long been understood as potential problems for both air quality and more recently as a contributing factor to global climate change. The prior art addressing these concerns is divided into two general categories of invention. First, apparatus and processes designed to sequester “greenhouse gases” at their source, generally a hydrocarbon combustion flue attached to an industrial process requiring heat and energy to produce products or deliver services. These apparatus and processes generally include the chemical decomposition, physical absorption or reprocessing of carbon dioxide or other undesirable gases into more desirable and manageable states of matter. The flow of carbon dioxide from industrial flue streams often in high concentrations and with the benefit of waste heat significantly enhances opportunities for sequestration or reprocessing.

Generally speaking a significantly developed body of prior art exists for controlling the exhaust of carbon dioxide into the atmosphere from localized combustion streams. There are also many successful technologies for improving the combustion efficiencies of both fuels and processes to reduce carbon dioxide in exhaust streams.

A second body of prior art that is much less well developed relates to the problem of taking carbon dioxide from the atmosphere when it is produced from multiple decentralized sources, for example automobile exhaust and exists in the general atmosphere in relatively small, although increasingly problematic concentrations. Apparatus and processes designed specifically to address this problem are just beginning to emerge. Most notable is the so called “artificial tree” that ingeniously utilizes wind energy to drive air through a chemical filter separating the carbon dioxide from the air stream so that it can be sequestered as a gas in some suitable “carbon sink” or used under pressure to assist in a related industrial process, for example to pressurize oil and gas wells for increased production. This technology is site specific only as a requirement of having a suitable repository for the collection and sequestration of carbon dioxide gas.

Further distinctions between my invention and the existing prior art will become increasingly obvious as a discussion of the inventions objects and advantages develops.

### SUMMARY OF THE INVENTION OBJECTS AND ADVANTAGES

The objects and advantages of the invention are numerous. Most important is that the technology represents a means for slowing the accumulating concentrations of atmospheric CO2 identified as resulting from human activity and contributing to the phenomena and crisis of global climate change. A deployment of the invention in any of its many potentially commercial product embodiments cleans CO2 from the atmosphere and produces high value by-product in direct relationship to the amount of solar radiation collected and focused to power the process of the invention. Rapid large scale deployment of solar collection surface produces corresponding rapid and large mitigations of the CO2 concentrations attributed to causing of global climate change. It is theoretically possible to deploy the invention at a scale that could stabilize increasing CO2 concentrations.

A further advantage is that the by-product produced by the process of the invention can be a liquid or solid that can be easily collected and confined without significant additional energy expenditures for pumping and pressurizing. The by-products of the process of the invention have high commercial value and thereby can be sold to offset the capital and maintenance costs incurred. Further the by-products can be easily refined using known technology into an alternative fuel source. Utilizing this fuel source in a combustion process could have a neutral effect in the environment eliminating increased CO2 contributions to the atmosphere. Additionally, producing an alternative fuel by means of an environmentally benign energy source (solar) from a heretofore untapped natural resource (the earth's atmosphere) is highly desirable as hydrocarbon energy sources become less available, more expensive and contributors to increased CO2 concentrations.

Another advantage is that a major component of the invention, thermally power photonic crystals, are used in a new way as a means to produce suitable frequencies and power for the dissociation of molecular matter to neutral fragments. It is anticipated that photonic crystals used to produce specifically unique frequencies and power levels can be designed and employed as a means for the dissociation and reduction of molecular matter into a broad variety of useful products. The dissociation of methane (CH4) for example to produce hydrogen by means of solar driven thermally powered photonic crystals could be an extremely valuable new use. As could the deployment of embodiments of the current invention design to dissociate other greenhouse gases for example, nitrous oxide (N2O).

It is anticipated that embodiments of the invention can be designed and produced in suitable product models to provide utility at all levels of the marketplace, consumer, commercial and industrial. This enhances the rapidity of deployment and provides a means for market forces to respond directly to global climate change. Individual consumers, businesses and industry can use the various embodiments and product models of the invention both to reduce CO2 concentrations and produce useful valuable commercial by-products, even alternative fuel resources without waiting for governments to take action. This is a highly desirable object of the invention in the context of the pending crisis of global climate change. Further, the modular nature of embodiments and the capability of the invention to produce an alternative fuel source, at any location on the surface of the earth, provides for decentralized fuel production opening access to a new energy resource, thereby improving general standards of living everywhere.

A further contemplated ramification of the invention is that it might be designed to include the staged cracking of molecular elements by means of a series of unique frequency fields each produced by radiation from photonic crystals. For example, an embodiment of the invention might be designed dissociate CO2 in a first stage producing carbon monoxide and oxygen. These products passing in series to a second stage designed to dissociate CO producing elemental carbon and oxygen. It might be anticipated that this ramification could include several stages for the progressive refinement of numerous molecular elements.

The advantages articulated herein are by no means the extent of the objects it can be anticipated will be produced by this invention. Rather they represent only a few possibilities and should be considered only as examples of the important utility derived from this invention and anticipated ramifications.

### BRIEF DESCRIPTION OF THE DRAWINGS

FIG. 1 A drawing illustrating the relationships of all the components of the apparatus

FIG. 2 A drawing illustrating the parts and there relationship to each other of the parts comprising the focal apparatus used to dissociate CO2 and react the by-product.

### REFERENCE NUMERALS

1—incoming solar radiation
2—solar parabolic concentrator dish
3—concentrated flux of solar radiation to focal point
4—air with CO2 entering ports in focal apparatus
5—air without CO2 leaving focal apparatus
6—focal apparatus of FIG. 2
7—member for positioning focal apparatus
8—base member for anchoring parabolic dish and tracking mechanism
9—gravity tube for transporting reactant away
10—acetic acid vessel and dispenser
11—frensel lens to enable photolysis of metal carbonyl
12—reactant by-product collection and storage box
13—reactant by-product accumulation in storage box 12
14—thermal receiver
15—photonic crystal
16—air inlet port
17—energy/matter mixing chamber
18—terahertz radiation field
19—expansion/cooling nozzle
20—reactant drip collection tray
21—exhaust cowling or conduit
22—filter membrane with reactant elements
23—fan

### DESCRIPTION OF THE INVENTION

It is know that all molecular elements absorb energy in unique frequency ranges. Specifically carbon dioxide absorbs energy in four modes: symmetric, asymmetric and two bend modes each excited by a specific frequency of radiation. It is also known that bodies of matter vibrating at the same frequency will transfer energy to the exclusion of surrounding bodies of matter.

Therefore it is possible to envision that a specific molecular element (CO2) of air having unique frequencies for energy absorption will absorb energy from a specifically frequency tuned and sufficiently powered field of radiation, as they pass through it, to the exclusion of other surrounding molecular elements comprising air having different and unique frequency absorption characteristics. This absorbed energy thereby exciting only a specific molecular element (CO2) producing a localized excitation sufficient to dissociate its covalent bond rendering it into neutral molecular fragments.

The invention works on this principle. It is powered by a primary solar concentrator (2) or an array of concentrators with capability to track the movement of the sun across the sky and reflect solar radiation to a focal point thereby, producing a concentrated flux of power (3). Generally, the power source will be a parabolic solar concentrator (2) having a radiation collection surface large enough to provide the power requirements that exist at the focal point apparatus (6). Sizing and design of solar concentrating collectors (2) is a well known art and the specifications of the inventions solar power source can be varied to meet the solar thermal power requirements that exist at the focal point (6) and will be defined further herein.

In an embodiment of the invention, a connecting member (7) positions the apparatus at the focal point (6) of the primary concentrator (2) is configured with the objective of dissociating atmospheric carbon dioxide molecules in free air leading to the production of a useful metal carbonyl that could be further refined into an alternative fuel source. This process could produce a closed fuel cycle neutral to the environment thereby stabilizing increased concentrations of atmospheric CO2. For example, as an alternative fuel source iron pentacarbonyl, when combusted in oxygen produces CO2 in the same quantity as was removed from the atmosphere by the cleaning or molecular dissociation process resulting in no net gain in the atmospheric concentrations of CO2.

2Fe(CO)5(liquid)+5O2(gas)=2(Fe)(solid)+(10CO2)(gas)

Beginning the description by pointing out a new use for a thermally powered terahertz radiation source using photonic crystals (15) (U.S. Pat. No. 7,078,697) solar energy (1) is used to power the process and dissociate “greenhouse gases” specifically CO2. Find at the focal point apparatus (6) of a primary concentrator (2) the thermally conductive, preferably selective, solar receiver (14) of a thermally powered photonic crystal (15) positioned by a member (7) and fabricated to be an efficient receiver for a concentrated flux of solar energy (3). At the focal point (6) incident solar radiation (3) is transformed to thermal energy driving a photonic crystal (15) design to produce specific frequencies at suitable power levels resulting in localized internal excitation of CO2 molecules in a free air stream and its dissociation to neutral fragments. The thermally powered photonic crystal (15) in the focal point apparatus (6) can be of any shape but is preferably cylindrical and of an approximately larger diameter then that presented by the flux of concentrated solar energy (3) from said primary concentrator (2). The design specifics of a thermally powered terahertz radiation source using photonic crystals is explained and further referenced in the aforementioned patent, Barker et al. The axis of the thermally powered crystal's (15) thickness being aligned with the incoming flux of solar energy (3) so that the incident flux strikes the thermal receiver (14) and frequency and power emanate from the surface of the photonic crystal (15) on the opposing side. It is reasonable to assume that this configuration might be optimized by designing defect cavities, waveguides and other features as taught in Barker et al. The photonic crystal (15) component is surrounded and affixed to an enclosing conduit or mixing chamber (17) that is of suitable design and appropriately shaped to produce a mixing cavity (17) wherein a field of terahertz radiation (18) having the correct frequency and power is produced. Air inlet ports (16) approximate the focal point end of the mixing chamber (17) should be suitable for drawing in atmospheric gases including CO2 (4). At the opposite end of the energy/matter mixing cavity (17) a nozzle (19) narrows a moving air stream powered by an exhaust fan (23) by creating a negative pressure in the mixing chamber (17) for pulling free air (4) into the inlet ports (16) through the apparatus and exhausting it back to the atmosphere (5). On the expansion side of the nozzle (19) and up stream to the direction of the air flow a filter (22) of suitable design to be impregnated with any of several metals or other elements that are known to react with carbon monoxide is positioned in the air stream and affixed to the exhaust cowling (21). A preferred metal is iron (Fe) its reaction with carbon monoxide in the air stream produces the metal carbonyl, iron pentacarbonyl [Fe(CO)5] a free flowing liquid that gravity drips to a collection tray (20) and is transported by means of tubing (9) to a photolysis chamber or reactant/collection storage box (12) having a frensel lens where sunlight (1) or light from an alternative source and the addition of acetic acid from dispenser (10) can be mixed to produce a reaction resulting in the by-product diiron nonacarbonyl [Fe2(CO)9] an insoluble, nonvolatile crystal of high commercial value. Dirron nonacarbonyl having an advantage as a desirable end product because it is reasonably easy and safe to handle and can be collected and stored for later removal from a storage box (12).

This embodiment of the invention operates in the following manner. Utilizing the incident solar energy (1) reflected from a primary concentrator (2) a solar receiver (14) in the focal point apparatus (6) is energized providing the thermal power to produce terahertz radiation of appropriate frequency and power by means of a specifically designed photonic crystal (15) as taught in Barker et al. A terahertz radiation field from said photonic crystal (15) is confined by mixing cavity (17) with boundaries defined by material comprising appropriately designed surrounding surfaces the emanating surface of the photonic crystal (15) at one end and the exhaust nozzle (19) opposing the crystal at the other end. This cavities (17) design is specific to creation of a field of radiation (18) at an appropriate frequency and power to cause localized internal heating or excitation of CO2 molecules in free air (4) passing through inlet ports (16) of said chamber (17) to the majority exclusion of other matter normally comprising air.

CO2 molecules are thereby dissociated to the neutral fragments carbon monoxide CO and oxygen and are pulled through the nozzle (19) in the moving air stream powered by a fan (23) where some expansion cooling tends to mitigate recombination. CO molecules intersect the filter membrane (22) in the air stream and react with iron fragments imbedded in the filter (22) resulting in a reaction producing iron pentacarbonyl, a flammable liquid. The filter (22) having been designed and position appropriately to allow iron pentacarbonly or other metal carbonyl liquids to drip to a tray (20) for collection and gravity transport by a tube (9) to a photolysis reaction chamber (12) of suitable design to be reacted with sunlight and acetic acid producing for example, diiron nonacarbonyl, a reactant by-product (13) that can be stored safely and easily for removal later. These reactions and the means to produce them are well known in the arts of metallurgy. Metal carbonyls and its associate group of metal elements are preferred reacts but should not be construed as the only reacting elements that might be utilized in the process described.

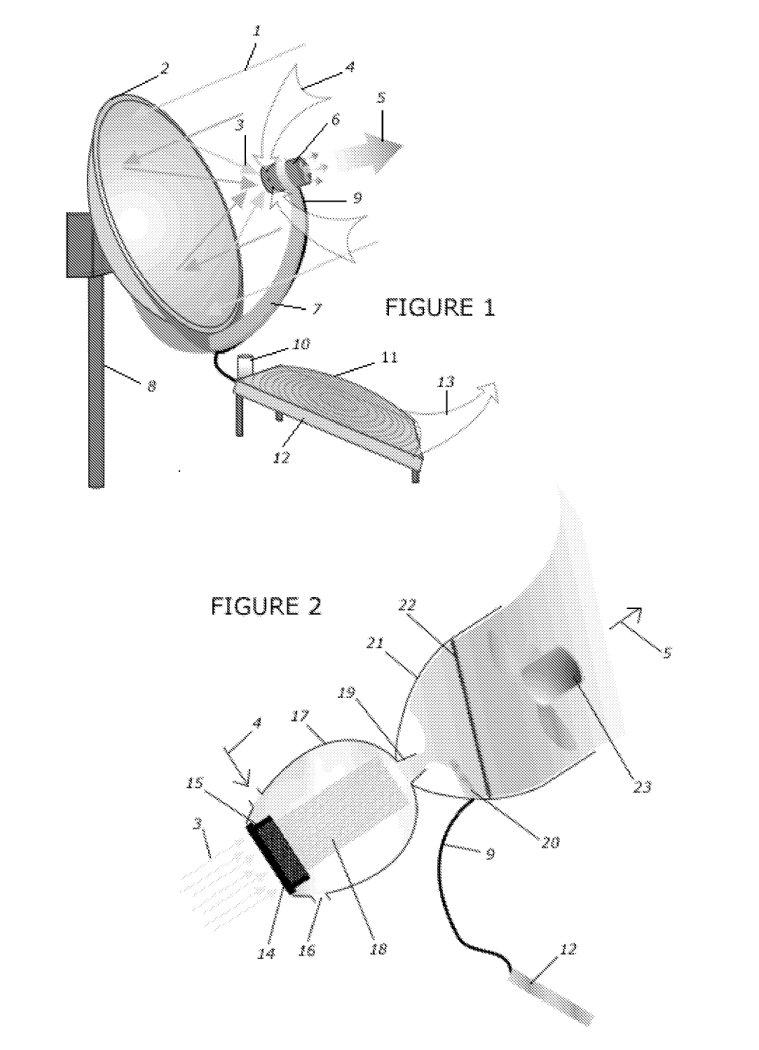

By way of a further explanation of the operation of the invention it is helpful to look at a dynamic view of the process. Assume that a resonant frequency field (18) is maintained as a constant as long as the sun is inputting energy (1) to the invention (FIG. 1). Further, assume that the air flow through the apparatus (FIG. 2) powered by fan (23) is at a constant CFM and that a given cubic foot of air contains 0.0003792 moles of CO2 (approximately 0.2 grams or 0.03% of total atmospheric gases).

The energy requirement to dissociate single CO2 molecules is a function of the energy required to dissociate one mole of CO2 (803 kJ) divided by 6.023×10 to the 23rd (Alvarado's number), a relatively small amount of energy (133.34×10 to the −19 joules per molecule).

Make the assumption for this explanation that both energy (solar) and matter (air) are flux streams. Therefore, single molecule dissociation takes place at unique points in time as matter and energy intersect in the resonant field as they both flow through the system of the apparatus. The energy required to produce an appropriately tuned resonant frequency field (7.4 um, for example) with power sufficient to dissociate CO2 molecules needs to be only as great as the number of single molecules flying through the radiation field at any one time.

### Assumptions:

1.6429×10 to the 19 molecules of CO2 per cubic foot of air 133.34×10 to the −19 joules per molecule (energy required to dissociate one molecule CO2)

One half square meter of solar concentrating collector produces an average 300 watts of power per hour.

Apparatus flow rate 60 cubic feet per minute or 1 cubic foot per second

### Calculations and Conclusions:

1.643×10 to the 19th molecules/cubic feet multiplied by 133.34×10 to the −19th joules/molecule=219 joules/cubic foot=0.219 Kilojoules/cubic foot=219 watt-seconds. This equals the power required to dissociate the group of CO2 molecules in one cubic foot of air as they pass through the apparatus at a rate of one cubic foot per second.

Solar Power into the apparatus 300 watt-hours=1080000 watt-seconds.

Looking at the operation of the apparatus (FIG. 2) as a dynamic with both energy and matter passing through at prescribed and constant rates then the energy requirement to dissociate the unique molecule group passing through a resonant frequency field (18) produced in the apparatus can be summarized thus. If you double the resonant frequency field (18) requirement to insure molecular dissociation (440 watt-seconds) and assume thermal to photonic conversion efficiency of 0.5% (5400 watt-seconds) you have more then ten times the required power to cause CO2 molecular dissociation in the matter stream. Further, it is known that not all CO2 molecules will dissociate this is often referred to as the quantum efficiency of the process. To enhance and improve quantum efficiency there are two strategies that can be easily designed into embodiments of the invention. First, is to simply increase the power of the frequency radiation field (18) produced by the photonic crystal (15). Generally the efficiency of a thermally driven photonic crystal (15) is on the order of one percent (1%). For every one hundred units of thermal energy in one unit of radiation energy at the design frequency is produced. Therefore enlarging the solar collection surface will increase the power of the frequency field (18) produced by the photonic crystal (15). Although this works and higher powered frequency fields will produce a higher quantum efficiency of dissociation. Economics and scaling issues enforce practical limits. Second, it is feasible to design a means to pulse the photonic radiation field (18), thereby delivering bursts of photonic energy on short time intervals but higher power levels, thereby improving quantum efficiencies of dissociation. The design of the circuitry required to initiate a heat pulse is a well known art and could be powered from an alternative source via photovoltaic cells or the waste heat collected from the apparatus by for example pyro-electic crystal material could be used.

Of significant interest and an unanticipated synergy of invention produces a closed loop of fuel production the utilization of which, is neutral to increasing concentrations of CO2 in the atmosphere. Metal carbonyls generally are high grade fuel sources rich in carbon monoxide. Iron pentacarbonyl and other metal carbonyls that could be produced can be refined into numerous high value commercial and industrial products. In the neutral fuel cycle of this process molecules of CO2 dissociate by means of the frequency and power produced by solar energy and result in molecules of CO and molecules of oxygen. Combustion of iron pentacarbonyl in oxygen produces an equivalent number of molecules of CO2 plus iron (Fe) thereby, a closed cycle balance that produces no net increase in the concentration of CO2 in the atmosphere.

All of the parameters required to design the apparatus described herein are well known in the several arts to which they are related. It is thereby possible to begin with the minimum power levels required for covalent bond dissociation and build apparatus in any number of sizes, scales and designs as required by the operational objective of the device.

### CONCLUSION AND SCOPE OF THE INVENTION

Thus the reader will see that the invention provides for a means to effectively clear carbon dioxide from the atmosphere, providing a reduction in the increasing concentrations of CO2 in atmospheric gases and rendering useful and commercially valuable by-products.

While my above description contains various specificities, these should not be construed as limitations on the scope of the invention, but rather as an exemplification of embodiments thereof. The theoretical application of utilizing photonic crystals to create frequencies and power suitable for the elemental dissociation of other molecules into useful products opens many possible ramifications. For example, essentially the same apparatus could be design specifically for removing nitrous oxide (N2O) or other greenhouses gases from the atmosphere. Additionally the technology of using photonic crystals to produce resonant frequencies for dissociating other molecular structures is entirely feasible and is anticipated in the context of a new use for photonic crystals.

Accordingly, the scope of the invention should be determined not by the embodiments illustrated but by the appended claims and their legal equivalents.

I claim:

1. Apparatus for cleaning carbon dioxide from the atmosphere comprising:
a) a thermally powered photonic crystal producing radiation
b) a mixing cavity attached to said photonic crystal for intersecting a flux of radiation energy with a stream of atmospheric matter
c) a plurality of atmospheric inlet ports in said mixing cavity
d) an exhaust nozzle attached to said mixing cavity
e) an exhaust cowling for directing an exhaust stream from said nozzle
f) a filter membrane for holding reactant elements in said exhaust steam
g) a fan for pulling atmospheric gases through said apparatus
h) means to collect reactant by-products from said filter
i) means to power said apparatus with solar energy.

2. A method for cleaning carbon dioxide from the atmosphere comprising the steps in the order named:
a) producing a flux field of radiation energy of a specific frequency and power sufficient to excite carbon dioxide molecules
b) powering a gas stream of atmospheric matter
c) intersecting said energy flux and said matter stream, whereby said carbon dioxide molecules dissociate into neutral fragments of carbon monoxide and oxygen to the exclusion of other molecules in said gas stream
d) exhausting said gas stream containing neutral fragments
e) reacting the neutral fragment carbon monoxide in said gas stream with combining elements producing metal carbonyls
f) capturing metal carbonyl by-products from said gas stream
g) collecting and storing said by-products
h) exhausting a gas stream without carbon dioxide to the atmosphere.

3. A method for using thermally power photonic crystals producing terahertz radiation for dissociating diatomic and polyatomic gas molecules comprising to steps:
a) producing a flux of radiation of specific frequency and power to dissociate said molecules
b) intersecting said gas molecules with said radiation field
c) cooling said dissociated gas molecules, whereby recombination is substantially prevented.

4. An apparatus for cleaning carbon dioxide from the atmosphere comprising:
a) a means for producing a flux field of radiation energy of a specific frequency and power sufficient to excite carbon dioxide molecules
b) a means for powering a gas stream of atmospheric matter
c) a means for intersecting said energy flux and said matter stream, whereby said carbon dioxide molecules dissociate into neutral fragments of carbon monoxide and oxygen to the exclusion of other molecules in said gas stream
d) a means for exhausting said gas stream containing neutral fragments
e) a means for reacting the neutral fragment carbon monoxide in said gas stream with combining elements producing metal carbonyls
f) a means for capturing metal carbonyl by-products from said gas stream
g) a means for collecting said by-products
h) a means for exhausting a gas stream without carbon dioxide to the atmosphere.

5. Apparatus for removing carbon dioxide from the atmosphere to produce a metal carbonyl substance comprising:
a) a thermally powered photonic crystal producing radiation
b) a mixing cavity attached to said photonic crystal for intersecting a flux of radiation energy with a stream of atmospheric matter, whereby carbon dioxide molecules dissociate to carbon monoxide and oxygen molecules
c) a plurality of atmospheric inlet ports in said mixing cavity
d) an exhaust nozzle attached to said mixing cavity
e) an exhaust cowling for directing an exhaust stream from said nozzle
f) a filter membrane for holding reactant metal elements in said exhaust steam, whereby said metal elements react with said carbon monoxide producing said metal carbonyl
g) a fan for pulling atmospheric gases through said apparatus
h) means to collect said metal carbonyl from said filter
i) means to power said apparatus with solar energy.

6. A method for removing carbon dioxide from the atmosphere to produce metal carbonyl substances comprising the steps in the order named:
a) producing a flux field of radiation energy of a specific frequency and power sufficient to excite carbon dioxide molecules
b) powering a gas stream of atmospheric matter containing carbon dioxide
c) intersecting said energy flux and said matter stream, whereby said carbon dioxide molecules dissociate into neutral fragments of carbon monoxide and oxygen to the exclusion of other molecules in said gas stream
d) exhausting said gas stream containing said neutral fragment carbon monoxide
e) reacting the neutral fragment carbon monoxide in said gas stream with combining metal elements producing metal carbonyls
f) capturing metal carbonyl substances from said gas stream
g) collecting said metal carbonyl substances
h) exhausting said gas stream without carbon dioxide to the atmosphere.

7. An apparatus for removing carbon dioxide from the atmosphere to produce a metal carbonyl substance comprising:
a) a means for producing a flux field of radiation energy of a specific frequency and power sufficient to excite carbon dioxide molecules
b) a means for powering a gas stream of atmospheric matter containing said carbon dioxide
c) a means for intersecting said energy flux and said matter stream, whereby said carbon dioxide molecules dissociate into neutral fragments of carbon monoxide and oxygen to the exclusion of other molecules in said gas stream
d) a means for exhausting said gas stream containing the neutral fragment carbon monoxide
e) a means for reacting the neutral fragment carbon monoxide in said gas stream with combining metal elements to produce said metal carbonyls
f) a means for capturing metal carbonyl substances from said gas stream
g) a means for collecting said metal carbonyl substances
h) a means for exhausting said gas stream to the atmosphere.
